(19) United States
(12) Patent Application Publication
(10) Pub. No.: US 2013/0277527 A1
(43) Pub. Date: Oct. 24, 2013

(54) BREAK-AWAY COUPLING WITH ENHANCED FATIGUE PROPERTIES FOR HIGHWAY OR ROADSIDE APPURTENANCES

(71) Applicants: Arthur M. Dinitz, Westport, CT (US); Michael S. Stenko, Ridgefield, CT (US); Mahmoud Reda Taha, Albuquerque, NM (US)

(72) Inventors: Arthur M. Dinitz, Westport, CT (US); Michael S. Stenko, Ridgefield, CT (US); Mahmoud Reda Taha, Albuquerque, NM (US)

(73) Assignee: Transpo Industries, Inc.

(21) Appl. No.: 13/454,267

(22) Filed: Apr. 24, 2012

(51) Int. Cl. F16M 13/00

(52) U.S. Cl. 248/548

(57) ABSTRACT

A break-away coupling has a central axis and a necked-down central region formed by two inverted truncated cones having larger and smaller bases joined at the smaller bases by a narrowed transition region in the form of a catenoid having a radius R and a central plane of symmetry at its inflection point of minimum diameter. The length of the side of cone between the bases is equal to 1, the distance along the axis between each large base and the central plane equal to H, and:

$${H}^{2} = {R}^{2} + {1}^{2}$$

$$Sin θ = \frac{{h}_{1}}{l}$$

$$Where$$

$$H = \sqrt{{( 0.521 - R )}^{2} + {( 0.57 )}^{2}} , BC = R , and$$

$$l = \sqrt{{( 0.521 - R + \sqrt{{R}^{2} - {h}_{2}^{2}} )}^{2} + {( {h}_{1} )}^{2}}$$

$$H = {h}_{1} + {h}_{2}$$

where h₁=height of cones between bases, and
h₂=axial distance along central axis between each smaller base and the central plane.

### BACKGROUND OF THE INVENTION

1. Field of the Invention

The present invention generally relates to break-away couplings for lighting poles or appurtenances mounted along highways and roadways and, more specifically, to such a break-away coupling with enhanced fatigue properties.

2. Description of the Prior Art

Many highway and roadside appurtenances, such as lighting poles, signs, etc., are mounted along highways and roads. Typically, these are mounted on and supported by concrete foundations, bases or footings. However, while it is important to securely mount such roadside appurtenances to withstand weight, wind, snow and other types of service loads, they do create a hazard for vehicular traffic. When a vehicle collides with such a light pole or sign post, for example, a substantial amount of energy is normally absorbed by the light pole or post as well as by the impacting vehicle unless the pole or post it is mounted to be readily severed from the base. Unless the post is deflected or severed from the base, therefore, the vehicle may be brought to a sudden stop with potentially fatal or substantial injury to the passengers. For this reason, highway authorities almost universally specify that light poles and the like must be mounted in such a way that they can be severed from the support structure upon impact by a vehicle.

In designs of such break-away couplings several facts or considerations come into play. The couplings must have maximum tensile strength with predetermined (controlled) resistance to bending. Additionally, the couplings must be easy and inexpensive to install and maintain. They must, of course, be totally reliable.

Numerous break-away systems have been proposed for reducing damage to a vehicle and its occupants upon impact. For example, load concentrated break-away couplings are disclosed in U.S. Pat. Nos. 3,637,244, 3,951,556 and 3,967,906 in which load concentrating elements eccentric to the axis of the fasteners, for attaching the couplings to the system oppose the bending of the couplings under normal loads while presenting less resistance to bending of the coupling under impact or other forces applied near the base of the post. In U.S. Pat. Nos. 3,570,376 and 3,606,222, structures are disclosed which include a series of frangible areas. In both cases, the frangible areas are provided about substantially cylindrical structures. Accordingly, while the supports may break along the frangible lines, they do not minimize forces for bending of the posts and, therefore, generally require higher bending energies, to the possible determent of the motor vehicle.

In U.S. Pat. No. 3,755,977, a frangible lighting pole is disclosed which is in a form of a frangible coupling provided with a pair of annular shoulders that are axially spaced from each other. In a sense, the annular shoulders are in the form of internal grooves. A tubular section is provided which is designed to break in response to a lateral impact force of an automobile. The circumferential grooves are provided along a surface of a cylindrical member.

A coupling for a break-away pole is described in U.S. Pat. No. 3,837,752 which seeks to reduce maximum resistance of a coupling to bending fracture by introducing circumferential grooves on the exterior surface of the coupling. The distance from the groove to the coupling extremity is described as being approximately equal to or slightly less than the inserted length of a bolt or a stud that is introduced into the coupling to secure the coupling, at the upper ends, to a base plate that supports the post and to the foundation base or footing on which the post is mounted. The grooves are provided to serve as a stress concentrators for inducing bending fracture and to permit maximum effective length of moment arm and, therefore, maximum bending movement. According to the patent, the diameter of the neck is not the variable to manipulate in order to achieve the desired strength of the part, as the axial (tensile/compressive) strength is also affected.

However, the above mentioned couplings have shown signs of limited fatigue strength and, therefore, premature failure. Fatigue strength is a property of break-away couplings that has not always been addressed by the industry, partly because of the complex nature of the problem and its solution.

U.S. Pat. No. 5,474,408, assigned to Transpo Industries, Inc., the assignee of the present invention, discloses a break-away coupling with spaced weakened sections. The controlled break in region included two axially spaced necked-down portions of smaller diameter and solid cross section. The dimensions of the coupling were selected so the ratio D/L is within the range V/L<=0.3 where L is the axial control breaking region and the necked-portion has a diameter D. The necked-portions have conical type surfaces to assure that at least one of the necked-portions break upon bending prior to contact between any surfaces forming or defining the necked-portions.

A multiple necked-down break-away coupling has been disclosed in U.S. Pat. No. 6,056,471 assigned to Transpo Industries, Inc., in which a control breaking region is provided with at least two axial spaced necked-portions co-axially arranged between the axial ends of the coupling. Each necked-portion essentially consists of two axially lined conical portions inverted one in the relation to the other and generally joined at their apices to form a generally hour-glass configuration having a region of a minimum cross section at an inflection point having a gradually curved concave surface defining a radius of curvature. Each of the necked-down portions have different radii of curvature that are at respective inflection points to provide preferred failure modes as a function of a position in direction of the impact of a force.

The prior patented steel couplings will be referred to as “Existing” for the one Transpo Industries has used in the field for the last 30 years and “Alternative” for the more recently developed coupling. However, these “Existing” couplings have shown signs of limited fatigue strength. Therefore, a new coupling design was sought that would show marked improvements in fatigue strength.

### SUMMARY OF THE INVENTION

It is, accordingly, an object of the present invention to provide a break-away coupling for a highway or roadway appurtenance which does not have the disadvantages inherent in comparable prior art break-away couplings.

It is another object of the present invention to provide a break-away coupling which is simple in construction and economical to manufacture. It is still another object of the present invention to provide a break-away coupling of the type under discussion which is ample to install and requires minimal effort and time to install in the field.

It is yet another object of the present invention to provide a break-away coupling as in the aforementioned objects which is simple in construction an reliable, and whose functionality is highly predictable.

It is yet another object of the present invention to provide a break-away coupling as in the previous objects which can be retrofitted to most existing break-away coupling systems.

It is still a further object of the present invention to provide a break-away coupling which minimizes forces required to fracture the coupling in bending while maintaining safe levels of tensile and compressive strength to withstand non-impact forces, such as wind load.

It is yet a further object of the present invention to provide break-away couplings of the type suggested in the previous objects which essentially consists of one part and, therefore, requires minimal assembly in the field and handling of parts.

It is an additional object of the present invention to provide a break-away coupling as in the above objects geometrically optimized to enhance the fatigue properties of the coupling.

In order to achieve the above objects, as well as others which will become apparent hereafter, an improved steel break-away coupling design has a central axis and a necked-down central region formed by two inverted truncated cones having larger and smaller bases joined at the smaller bases by a narrowed transition region defining a catenoid having a radius R and a central plane by symmetry normal to said axis at its inflection point of minimum diameter, the length of the side of each cone between said bases being equal to 1, the distance along said axis between each large base and said central plane is equal to H, and wherein:

$$H = {h}_{1} + {h}_{2}$$

$${h}^{2} = {R}^{2} + {1}^{2}$$

$$Sin θ = \frac{{h}_{1}}{l}$$

$$Where$$

$$H = \sqrt{{( 0.521 - R )}^{2} + {( 0.57 )}^{2}} , and$$

$$l = \sqrt{{( 0.521 - R + \sqrt{{R}^{2} - {h}_{2}^{2}} )}^{2} + {( {h}_{1} )}^{2}} ;$$

and

where h₁=height of each cone between its bases, and h₂=axial distance along central axis between each smaller base and said central plane, and the coupling material, d, D, and H being selected to provide a coupling of a desired size that provides desired properties to make the coupling fail in shear and tension.

The optimization process is performed using the finite element method. The base angle of the coupling denoted “θ” was defined as the independent design variable. The relationships with other geometrical dependent variables were developed. A set of constraints for acceptable design of the coupling was defined. A combined multi-objective function to reduce the stress gradients in the necking and the cone areas is defined. The optimization process showed that an optimal design interval for the base angle θ=[26°-37°] exists. Within this interval the stress gradients are less than ⅓ of stress gradients developed with the current design θ=45°. The current design is obviously not an optimal design. It is recommended to fabricate the new couplings with base angles and geometry within the optimal interval. The new optimized coupling will have a higher fatigue strength compared with the Alternative (AL-1) couplings currently used.

### BRIEF DESCRIPTION OF THE DRAWINGS

Those skilled in the art will appreciate the improvements and advantages that derive from the present invention upon reading the following detailed description, claims, and drawings, in which:

FIG. 1 shows existing (E) and improved (ALI) break-away couplings side by side made by test galvanized steel;

FIG. 2 shows schematic representation for the coupling geometry and necking region including the design parameters;

FIG. 3 is a schematic for a single cone coupling;

FIGS. 4(a)-(f) are snapshots for selected cases for coupling geometrical optimization;

FIG. 5 shows dimensions for two-cone couplings;

FIG. 6 shows sensitivity analysis on the coupling's dimensions;

FIG. 7 shows Von Mises stresses at the ends of the cone and the necking;

FIG. 8 shows stress gradients at the transition zone within the two cones;

FIG. 9 shows multi-objective stress gradients at the transition zone in two cones;

FIG. 10 shows combined objective function for different base angle values showing the significant drop in objective function values of the modified design interval θ=[26°-37°] compared with existing design with θ=45′;

FIGS. 11a, 11b show geometry of boundaries of optimal design intervals;

FIGS. 12a, 12b show snapshots for finite element models of optimal design geometries;

FIG. 13 shows schematic representation for the general coupler geometry;

FIG. 14 shows a chain of six couplings of both types connected to a test frame;

FIG. 15 shows fatigue testing protocols showing the mean and amplitude of the fatigue load cycles for four test protocols 1-4 used to evaluate test couplings;

FIG. 16 shows fatigue testing protocols showing the mean and amplitude of the equivalent fatigue stress cycles for test protocols 1-4 used to evaluate test couplings;

FIG. 17 are side elevational views of fractured couplings;

FIG. 18 is comparison of the fatigue performance cycles to failure of Existing (E) and Alternative-1 (AL1) couplings;

FIG. 19 shows mean stress equivalent S-N curves for existing and alternative couplings;

FIG. 20 shows stress range equivalent S-N curves for existing and alternative couplings;

FIG. 21 shows a comparison of the fatigue cycles to failure of existing and alternative couplings under tension-compression fatigue cycles;

FIG. 22 is a stress range equivalent S-N curve for the existing and alternative couplings;

FIG. 23 is a comparison of the fatigue performance cycles to failure of existing and alternative couplings at 1 Hz and 2 Hz cycle frequencies;

FIG. 24 are close views of typical existing couplings after fatigue failures; and

FIG. 25 are close views of typical alternative couplings after fatigue failures.

### DESCRIPTION OF THE PREFERRED EMBODIMENTS

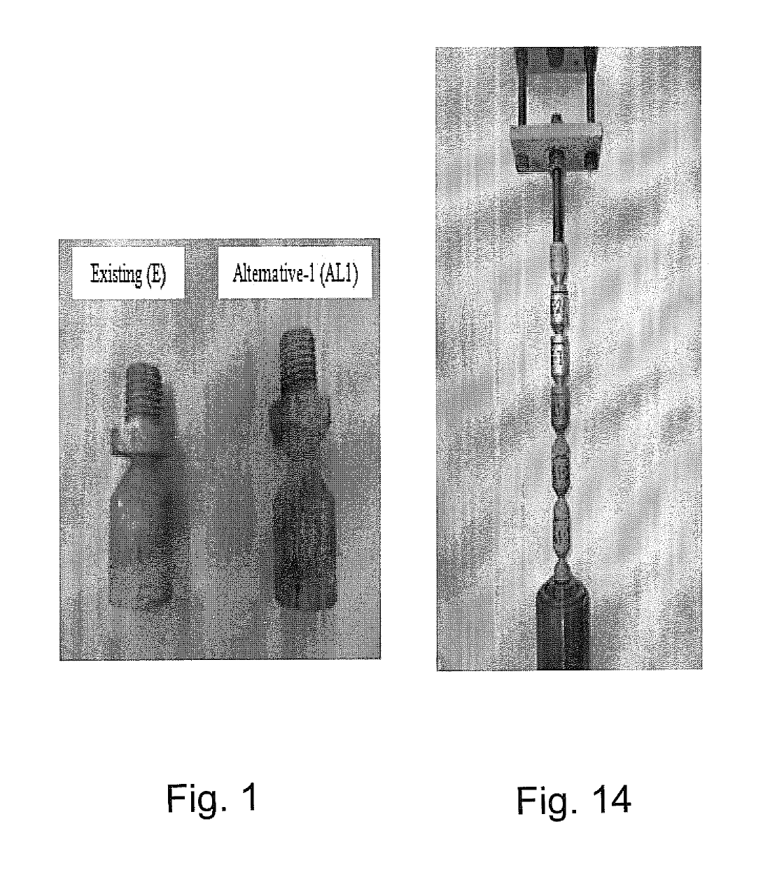

FIG. 1 shows a first type of coupling referred to as an “Existing” break-away coupling (E) while the second type is referred to as “Alternative-1” (AL1) or modified coupling. The difference between the two types is the geometry around the reduced section (necking), to be more fully described below.

The two types of couplings were modeled using finite element (FE) package ANSYS®. The main purpose of the FE model was to investigate the stress distribution in the necking zone and the locations of maximum stresses. The geometry of the Existing (E) and Alternative-1 (AL1) couplings is shown in FIGS. 28a-28d and 29a-29e respectively.

Two necking geometries were examined for the Alternative-1 (AL1) type couplings; G-1 and G-2. The first necking geometry, G-1, consisted of two cones connected by a catenoid and this geometry represents the design geometry. The second geometry, G-2, consists of two cones connected by a short cylinder with a smooth transition. A bilinear elastic stress-strain material model of steel was assumed with yield strength of 130 ksi. The steel was also assumed to have Young's modulus of elasticity of 29,000 ksi and Poisson's ratio of 0.3.

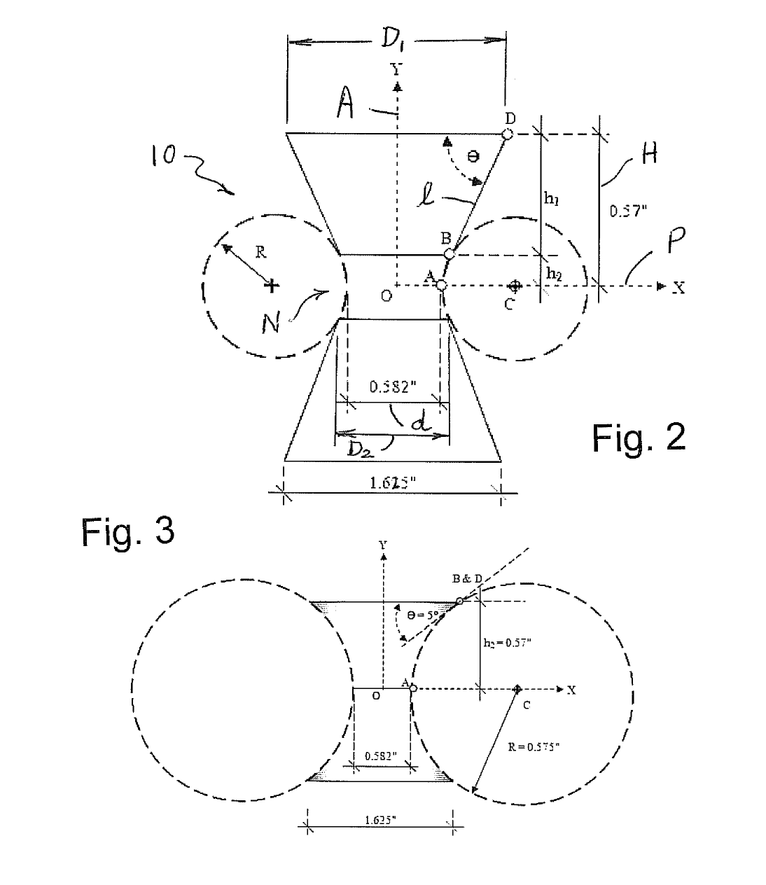

The invention seeks to optimize the design geometry of the “Alternative” couplings. The geometrical optimization was confirmed using a finite element method. The objective of the optimization process was to reduce stress gradients within the cone and the necking regions, as will be more fully described. These stress gradients are believed to control the fatigue life of the couplings. High stress gradients result in premature fatigue failure under cyclic loads. In particular, the objective of the design optimization is to identify the optimal intervals of the independent design variable defined here as a base angle θ. As will be more fully explained below, and referring to FIG. 2, all the other design variables are based on the base angle θ given the constraints to keep the base diameter D₁, the neck N diameter d and the coupling height H substantially constant and compatible with existing couplings and structures supported thereby. A schematic of the geometry of an optimized or modified coupling is shown in FIG. 2.

There are four variables in the design process. These variables are the base angle (θ), the radius of curvature R of the outer surface of the catenoid, The depth of the cone (h₁), and half the depth of the necking zone (the catenoid) (h₂). The coupling 10 has a central axis A, a central plane of symmetry P normal to the axis A and extends through the origin O. Assuming that the origin is located at the mid height and width of the necking region N (FIG. 2), there are four other characteristic points that determine the geometry of the necking region. These are A, B, C, and D. In addition, there are three design constraints described below:

1) The first constraint implies that the necking diameter remains constant (0.582″) to maintain the same shear design capacity of the couplings as in existing couplings. Therefore, the coordinates of point A is set as (0.291″,0) and the coordinate of point C is set as (0.291″+R,0).
2) The diameter of the larger base D₁ is also maintained constant of 1.625″. This is necessary to keep the diameter of the coupling unchanged. Therefore, the coordinates of point D is (0.812″, 0.57″).
3) The depth or height H of the necking region N is maintained 0.572″ as described by Eqn. (1). In addition, Eqn. (2) describes the limitation for minimum practical depths of h₁ and h₂.

h₁+h₂=0.57″ (1)

h₁ and h₂≦0.05″ (2)

4) The surface of the cone is maintained tangent to the outer circle of the catenoid at point B. This constraint guarantees smooth transition for the stresses between the cone and the catenoid. Consequently, the corresponding coordinates for point B is set as (0.291″+R−\sqrt{R²−h₂²}, h₂) and the line BC is equal to R and perpendicular to BD or 1, the side of the truncated cones. Given the coordinates of points B, C, and D, the Eqn. (3) a applies:

$$\begin{matrix}{h}^{2} = {R}^{2} + {l}^{2} & ( 3 ) \\ Also Sin θ = \frac{{h}_{1}}{l} \\ Where \\ H = \sqrt{{( 0.521 - R )}^{2} + {( 0.57 )}^{2}} , BC = R , and \\ l = \sqrt{{( 0.521 - R + \sqrt{{R}^{2} - {h}_{2}^{2}} )}^{2} + {( {h}_{1} )}^{2}} & ( 4 )\end{matrix}$$

A general geometrical design procedure is suggested below.

The main objective from the optimization is to minimize the stress gradient within the cone and the necking region N. In particular, the stress gradient between points A & B (SG_AB) and the stress gradient between points B & D (SG_BD) need to be minimized. The necking geometry has one independent variable which is the base angle (θ) and three dependent variables that fully describe the coupling geometry (R, h₁, h₂). For each iteration, the design variable (base angle) θ is assumed and the corresponding design parameters including the radius of curvature R, the depth or height of the cone h₁, and half the axial depth of the necking h₂ are computed using Eqn. (1), Eqn. (3), and Eqn. (4). Eqn. (2) is a design constraint used to limit iterations to practical design.

The stress gradients between points A & B (SG_AB) and points B & D (SG_BD) are calculated based on the gradient of Von Mises stress as described by Eqn. (5) & Eqn. (6) respectively. The objective function “F” is defined as a multi-objective function combining the two functions f₁ and f₂ from Eqn. (5) and Eqn. (6) respective.

$$\begin{matrix}{f}_{1} = SG\_AB = \frac{von Mises ( A ) - von Mises ( B )}{{h}_{2}} & ( 5 ) \\ {f}_{2} = SG\_BD = \frac{von Mises ( B ) - von Mises ( D )}{{h}_{1}} & ( 6 )\end{matrix}$$

The objective function “F” is formulated as a weighted sum of the two stress gradients as described by Eqn. (7).

F=w₁·ƒ₁+w₂·ƒ₂ (7)

where w₁ is the weight of the stress gradient between A&B, w₂ is the weight of the stress gradient between B&D. In this study, w₁ and w₂ are chosen to be ⅔ and ⅓ respectively. The preference made for SG_AB over SG_BD because our prior observations of fatigue behavior of the couplings (Phase I and Phase II of this study) showed that failure usually occurs in the necking region (AB). The base angle(s) θ with the lowest objective function value represents optimal design(s).

In addition to the optimization process, one single case with a single cone is examined where h₁=0 and h₂=0.57″. In this case, the cone does not exist and the necking represents the entire depth. The base angle in this case θ=5° and the radius of curvature R=0.575″. The geometry of the single cone case is depicted in FIG. 3. Only one stress gradient is calculated in this case for the entire depth and it is compared directly to other cases. This case is not produced within the optimization scheme as it violates the design constraint described by Eqn. (2). However, this is an important case to examine as it assumes a relatively smooth transition through the single cone.

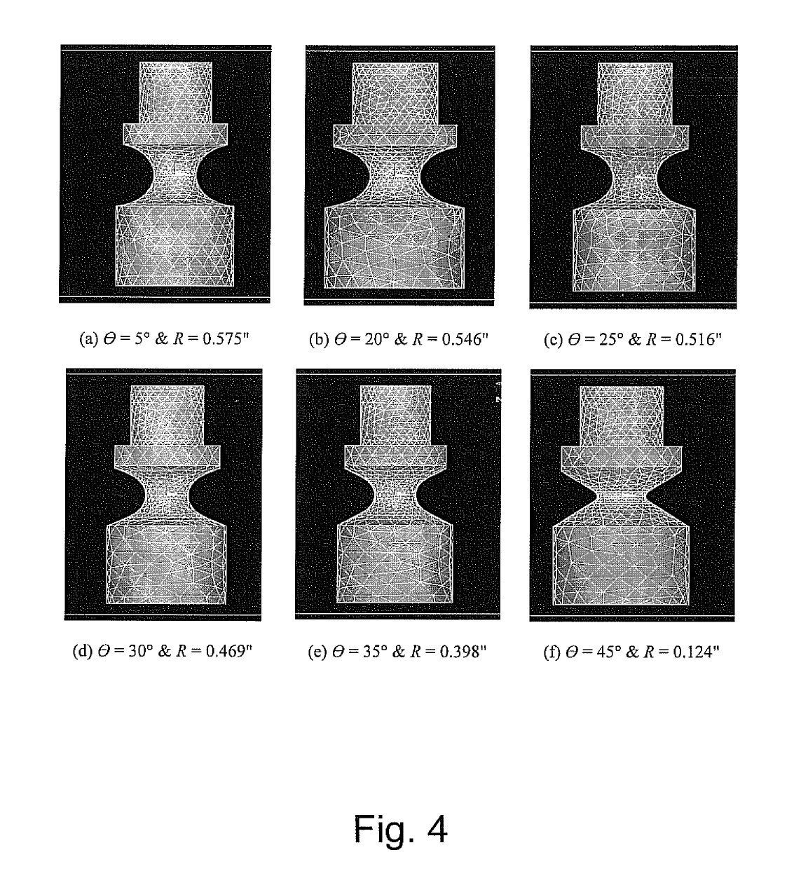

A wide range of simulation cases for optimization were performed with base angle θ ranging between 20° and 46° with 1° interval. It is noted that the current design for Alternative (AL-1) couplings is based on base angle of 45°. FIG. 4 shows snapshots for coupling's geometry for selected cases of the optimization simulations.

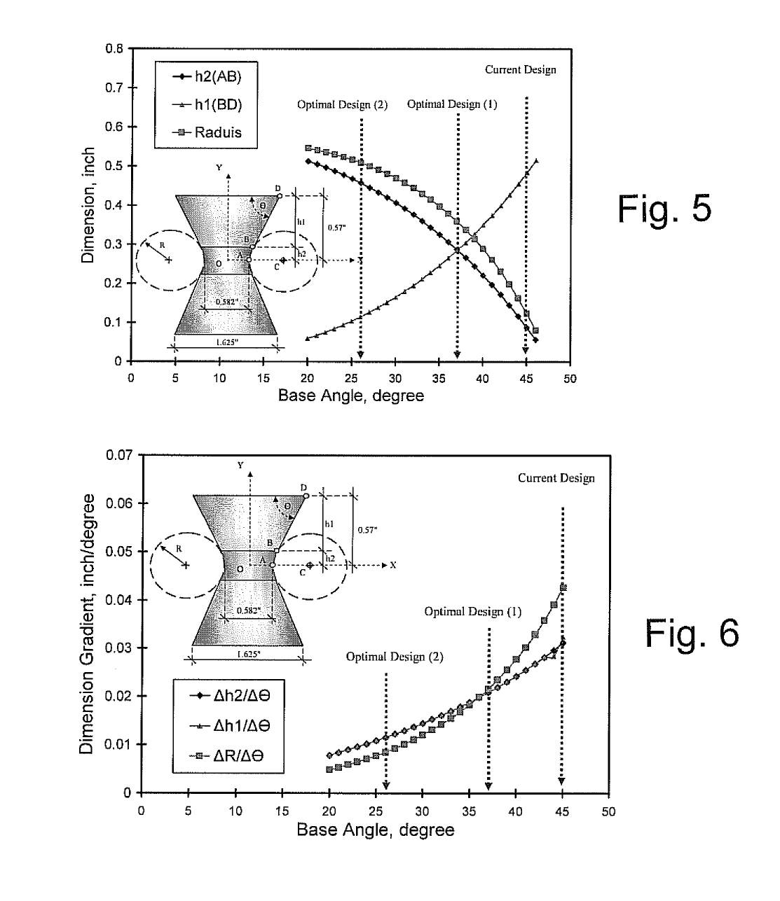

The single cone case described above in FIG. 3 was also analyzed. FIG. 5 depicts the change in coupling dimensions as a function of the base angle. As expected, the necking depth h₂ and the radius of curvature R increase nonlinearly with the increase of base angle θ. The cone depth h₁ decreases with the increase of base angle θ. The nonlinear relationship between the base angle θ and other dimensions demonstrates the complexity in the stress state and justifies the need for multi-objective optimization in order to determine the optimal coupling geometry.

It is also observed from FIG. 4 that the change in base angle θ has significant effect on the geometry of the coupling for relatively large base angles (>40°). As the base angle θ decreases, its effect on the coupling's geometry decreases gradually. For instance, there is no significant difference in geometry between FIGS. 4 (a-d) with base angles range θ between (5°-30°). On the other hand, FIGS. 4 (d-f), show base angles θ between (30°-45°), where significant change in the coupling's geometry takes place as the base angles changes.

A sensitivity analysis was performed to provide in-depth understanding of geometrical design sensitivity to the independent variable (base angle θ) The results of this sensitivity analysis are shown in FIG. 6.

In FIG. 6, the change in the dimensions with respect to the base angle θ is plotted along the domain of the base angle. The Fig. shows that at relatively high base angles (>40°) the change in dimensions is very sensitive to changes in the base angle. In design, it is recommended to have design geometry within a region of relatively low sensitivity. This would reduce the statistical variation of the mechanical response of the coupling due to relatively small variations in geometry during production. The analysis performed here proves that the current design (AL-1) falls within a region of very high geometrical sensitivity which is not good. Table (1) presents the dimensions and the results for all simulated cases for geometrical optimization. This includes a wide range of base angles θ 20-46° with 1° intervals.

TABLE (1)
All simulated cases for coupling geometry optimization.

| | | | | | Stress | Stress | |
|---|---|---|---|---|---|---|---|
| | Base | | Depth | | Gradient | Gradient | |
| | Angle | Radius of | of cone | Depth of | A-B | B-D | Objective |
| Case | (θ), | Curvature | (h₁), | necking | (SG_AB), | (SG_BD), | Function |
| # | degree | (R), inch | inch | (h₂), inch | f₁ ksi/inch | f₂ ksi/inch | (f), ksi/inch |
| 1 | 46 | 0.080 | 0.516 | 0.055 | 316.5 | 53.5 | 228.8 |
| 2* | 45 | 0.124 | 0.483 | 0.087 | 156.0 | 48.0 | 120.0 |
| 3 | 44 | 0.162 | 0.455 | 0.116 | 92.7 | 48.1 | 77.9 |
| 4 | 43 | 0.198 | 0.427 | 0.144 | 65.7 | 48.6 | 60.0 |
| 5 | 42 | 0.231 | 0.400 | 0.171 | 49.8 | 50.6 | 50.0 |
| 6 | 41 | 0.261 | 0.374 | 0.197 | 44.5 | 50.8 | 46.6 |
| 7 | 40 | 0.289 | 0.350 | 0.221 | 35.1 | 56.9 | 42.4 |
| 8 | 39 | 0.314 | 0.327 | 0.244 | 32.1 | 55.7 | 40.0 |
| 9 | 38 | 0.338 | 0.305 | 0.266 | 27.2 | 61.6 | 38.7 |
| 10† | 37 | 0.359 | 0.284 | 0.287 | 27.2 | 61.1 | 38.5 |
| 11 | 36 | 0.379 | 0.264 | 0.307 | 24.6 | 66.7 | 38.6 |
| 12 | 35 | 0.398 | 0.245 | 0.326 | 24.2 | 67.6 | 38.6 |
| 13 | 34 | 0.414 | 0.228 | 0.343 | 25.1 | 69.8 | 40.0 |
| 14 | 33 | 0.430 | 0.211 | 0.360 | 24.8 | 69.6 | 39.7 |
| 15 | 32 | 0.444 | 0.194 | 0.377 | 27.4 | 68.9 | 41.2 |
| 16 | 31 | 0.457 | 0.179 | 0.392 | 31.1 | 61.5 | 41.3 |
| 17 | 30 | 0.469 | 0.165 | 0.406 | 37.7 | 47.0 | 40.8 |
| 18 | 29 | 0.480 | 0.151 | 0.420 | 41.1 | 39.9 | 40.7 |
| 19 | 28 | 0.490 | 0.138 | 0.433 | 48.6 | 17.6 | 38.3 |
| 20 | 27 | 0.500 | 0.126 | 0.445 | 49.5 | 14.4 | 37.8 |
| 21† | 26 | 0.508 | 0.116 | 0.456 | 50.8 | 0.03 | 33.9 |
| 22 | 25 | 0.516 | 0.103 | 0.468 | 47.8 | 13.0 | 36.2 |
| 23 | 24 | 0.523 | 0.093 | 0.478 | 44.6 | 23.2 | 37.4 |
| 24 | 23 | 0.530 | 0.084 | 0.487 | 44.8 | 18.6 | 36.1 |
| 25 | 22 | 0.535 | 0.075 | 0.496 | 42.4 | 20.3 | 35.0 |
| 26 | 21 | 0.541 | 0.066 | 0.505 | 41.5 | 35.8 | 39.6 |
| 27 | 20 | 0.546 | 0.058 | 0.513 | 39.1 | 58.2 | 45.5 |
| 28‡ | 5 | 0.575 | — | 0.572 | — | 41.0 | 41.0 |

*current design,
†optimal design,
‡single cone case

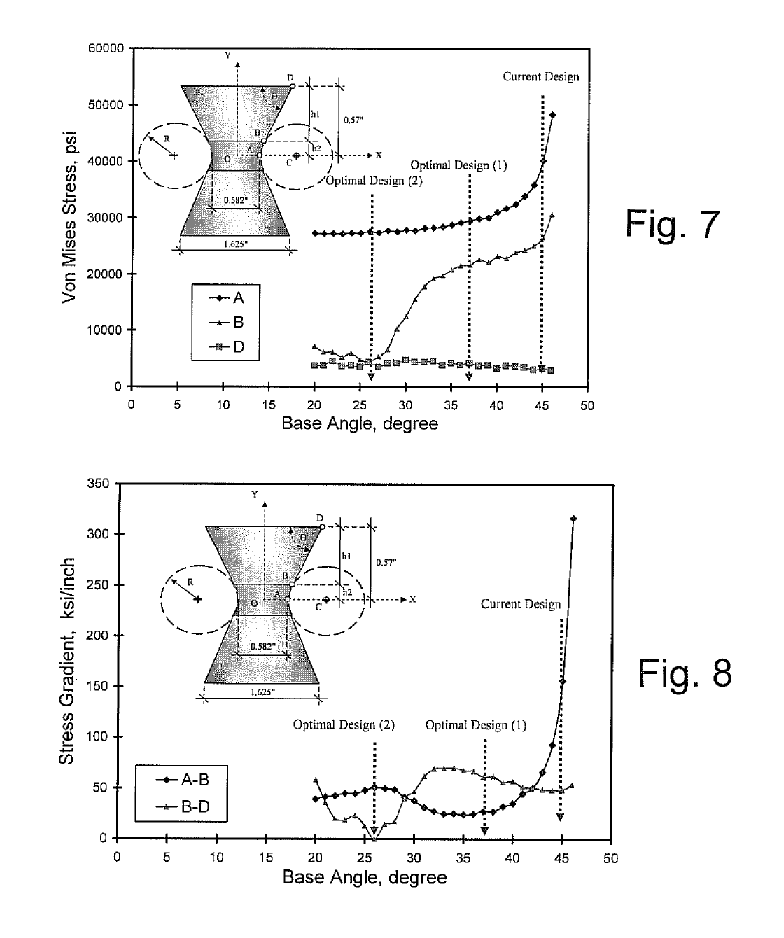

Von Mises stresses at the two ends of the necking (points A & B) and the cone (points B & D) are presented in FIG. 7. It is noted that Von Mises stress at point A increases exponentially with the increase in base angle θ while Von Mises stress at point B remains constant. However, Von Mises stresses at point B is obviously more complex and increases in high order polynomial fashion with respect to the increase in base angle θ. The complexity in the Von Mises stress profile is due to the simultaneous change in the location of the point, the cross sectional area of the respected plane, and the radius of curvature.

The stress gradients SG_AB and SG_BD are shown in FIG. 8. FIG. 8 also shows that above a base angle θ of 40°, SG_AB is very high and SG_BD is lower than its peak but still higher compared with much smaller angles such as 26°. As the base angle decreases, SG_AB decreases significantly and SG_BD increases slightly. As both gradients govern fatigue behavior, it is obvious that current geometry with high base angle θ=45° does not fall within an optimal design region/interval.

FIG. 9 shows the change in the stress gradient SG_AB and SG_BD as they are plotted against each other. FIG. 9 shows that the current design has a very high stress gradient SG_AB, while below base angle of 42° the two stress gradients are relatively low.

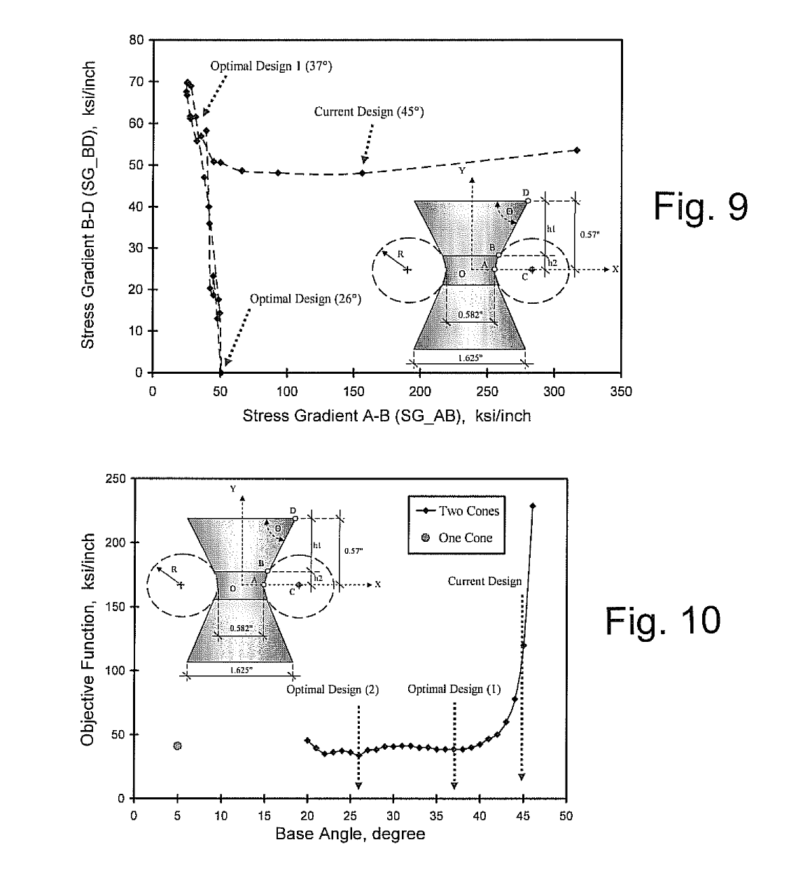

There exit two objectives: reducing the two stress gradients A-B and B-D. From FIG. 8, it can be seen that these objectives are not necessarily antagonistic. One technique to handle this case is to combine both objectives in a single objective function based on Eqn. 7. The combined objective function is calculated and plotted as a function of the base angle θ as shown in FIG. 10. Two regions for the combined objective function can be identified from FIG. 10. The first region is for large base angles (θ>40°) where the current design (θ=45°) exists. In this region, the combined objective function is very high and the design is therefore not an optimal one. The second region falls for small base angles (θ<b 40°). In this region, the combined objective function decreases significantly and approaches steady state or constant value between θ=26° and θ=37°.

The objective function of the current design is 120 ksi/inch, approximately three times the steady-state value (˜40 ksi/inch). This is because the base angle θ for the current design is relatively large (>40°) compared with the optimal design region θ=[26°-37°]. It is also apparent from FIG. 10, that the case of single cone (θ=5° shown in FIG. 2) will represent an optimal design with very limited combined objective function. The choice of a single cone design is a function of manufacturing needs to produce the needed fabrication sensitivity compared with the optimal region θ=[26°-37°] identified here.

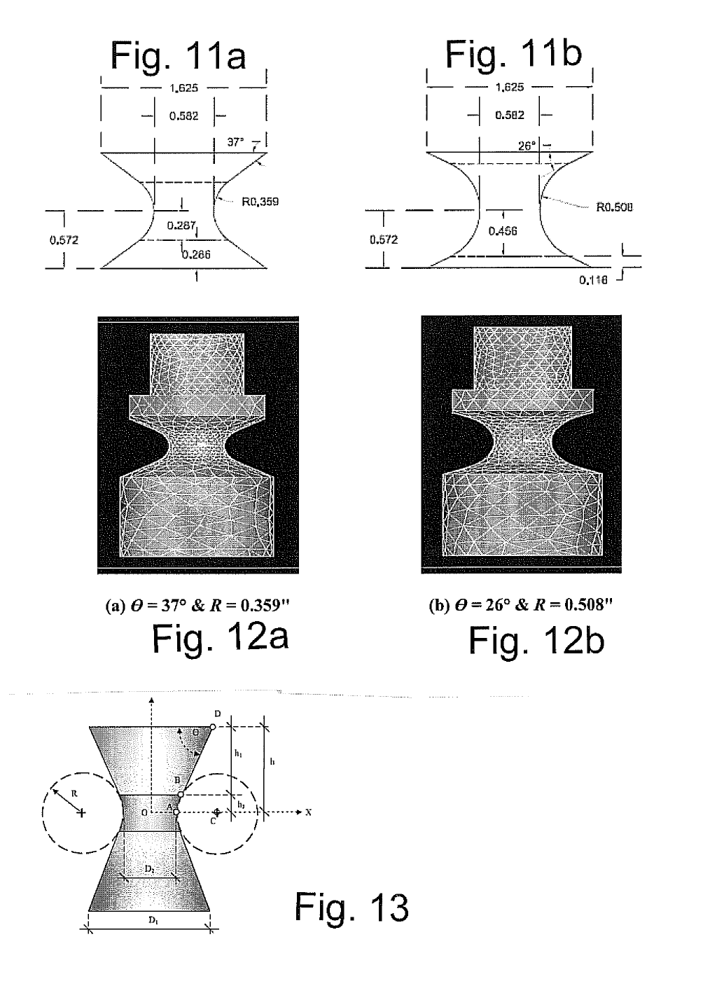

The geometrical optimization work reveals a design interval for the base angle between θ=[26°, 37°] where the combined objective function is significantly lower than the current design values at θ=45°. Values of the base angle θ within this design interval seem to produce couplings with limited stress gradients. This is believed to significantly enhance the fatigue performance of existing couplings. Dimensions and snapshots for the finite element models for the two geometries of the optimal design interval are shown in FIGS. 11 and 12 respectively. The optimal design interval can be produced using a θ=[26°, 37°], R=[0.359″, 0.508″], h₂=[0.285″, 0.456″] and h₁=[0.258″, 0.116″] respectively. The optimal design interval will produce a combined stress gradient objective function ranging from 33.9 to 38.5 ksi/inch. The stress gradients produced using the optimal geometry are less than ⅓ of the 120 ksi/inch gradient produced using the current design geometry with base angle θ=45°. Fabrication of new couplings with the optimal design geometries is recommended based on this study.

A general geometrical design for the necking region is suggested here. FIG. 13 shows the geometrical design variables. Based on the material properties, height, and cable diameter, three design parameters can be determined. These are the base diameter (D₁), necking diameter (D₂), and half the necking region height (h). The base angle θ can then be assumed as an independent design variable and three dependant design variables can be obtained by solving the three simultaneous equations (5)-(7). The three dependent design variables are the radius of curvature of the outer surface of the catenoid (R), The depth of the cone (h₁), and half the depth of the necking zone (the catenoid) (h₂).

$$\begin{matrix} {h}_{1} + {h}_{2} = H & ( 8 ) \\ {h}_{1} = Sin θ \sqrt{{( \frac{{D}_{1} - {D}_{2}}{2} - R + \sqrt{{R}^{2} - {h}_{2}^{2}} )}^{2} + {( {h}_{1} )}^{2}} & ( 9 ) \\ R = \sqrt{{( \frac{{D}_{1} - {D}_{2}}{2} - R )}^{2} + {( h )}^{2} - {( \frac{{D}_{1} - {D}_{2}}{2} - R + \sqrt{{R}^{2} - {h}_{2}^{2}} )}^{2} - {( {h}_{1} )}^{2}} & ( 10 )\end{matrix}$$

The new Alternative coupling has much higher fatigue strength. Fatigue testing as well as calibrated finite element (FE) modeling proved the higher fatigue strength of the Alternative coupling when compared with the Existing coupling. Moreover, the FE modeling showed a much lower stress concentration to be developed in the Alternative coupling when compared with the Existing coupling. The results also indicate that the geometry transition at the smallest dimension of the coupling plays a major role in its fatigue performance.

Both alternative or modified couplings are designed to meet AASHTO requirements for highway couplings. As a result of testing 90 couplings from both types under cyclic loading with different mean stress levels, different stress ranges and different stress frequency and determining the number of cycles to failure. The equivalent Stress-Number of Cycles to failure (S-N) curves for both couplings and report the type of fracture were observed under cyclic loading.

Fatigue tests were conducted on six couplings at a time connected by the male and female threads to form a chain as shown in FIG. 14. The chain was connected to a bottom platen with a threaded rod and to the top cross head with a two-plate bending frame. The frame was designed to avoid producing any bending moments that might occur due to eccentric loading. The row of six couplings consisted of three of each coupling type.

The purpose of the fatigue test is to determine the number of cycles to failure and develop an equivalent Stress-Number of Cycles to failure (S-N) curves to allow comparison of the fatigue behavior of the two types of galvanized steel couplings. We use the word “equivalent” here for describing the S-N curves as establishing the “true” S-N curves for the couplers requires testing very high number of specimens (>30 specimens) which is beyond the scope of this investigation. The two types of couplers are examined under cyclic loading. The test set-up is shown in FIG. 14. The first type of coupler is referred to as Existing (E) while the second type is referred to Alternative (AL). The difference between the two types is the geometry around the reduced section (necking). The test was conducted on series of maximum 10 couplers at a time connected by the male and female threads to form a chain as in FIG. 14. The chain is connected to the bottom platen with threaded rod and to the top cross head with plate bending frame. The frame is designed to avoid producing moments on the couplers.

Four test protocols were performed on a total of 20 specimens of each type of existing couplings. Each test protocol was cyclic load controlled with a frequency of 1 Hz. Mean tension loads and stresses vary as follows:

| | |
|---|---|
| Test protocol-1 | mean tension load of 4.85 kip, amplitude of 3.03 kip |
| | mean stress of 17.98 ksi, 51.59% of max stress test |
| Test protocol-2 | mean tension load of 6.37 kip, amplitude of 4.55 kip |
| | mean stress of 23.60 ksi, 67.72% of max stress test |
| Test protocol-3 | mean tension load of 7.88 kip, amplitude of 6.06 kip |
| | mean stress of 29.22 ksi, 83.85% of max stress test |
| Test protocol-4 | mean tension load of 9.40 kip, amplitude of 7.58 kip |
| | mean stress of 34.85 ksi, 100% of max stress test |

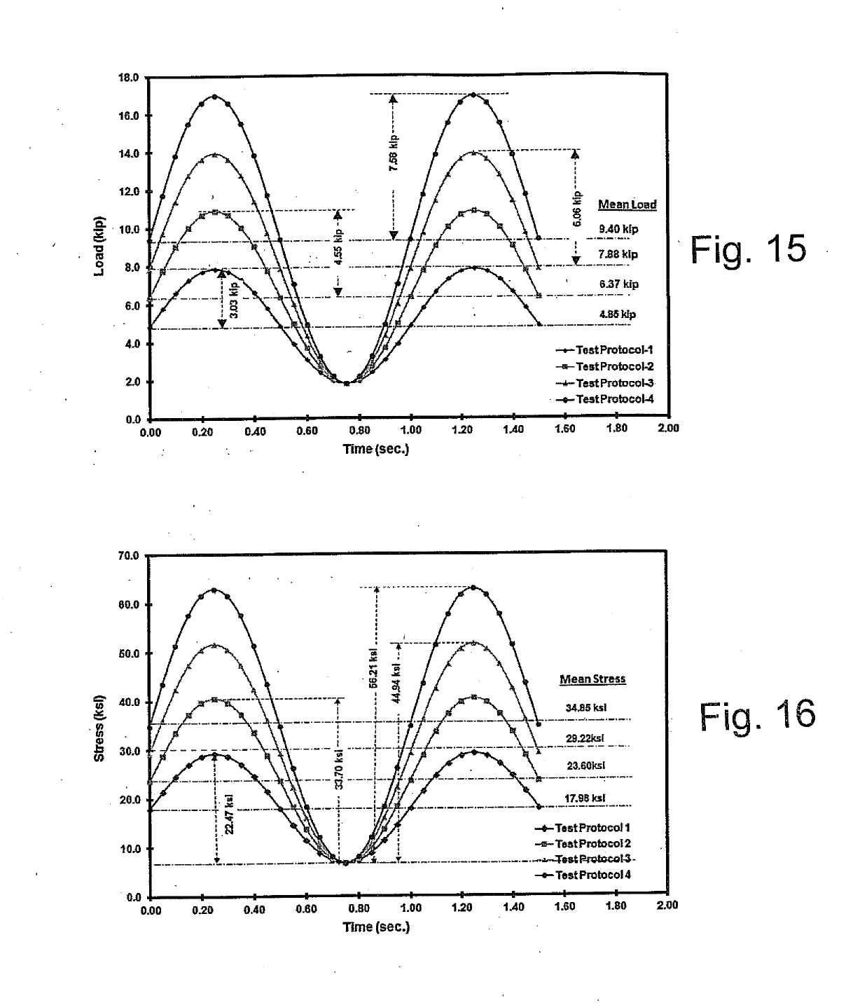

Couplings were kept under tension during test protocols 1 through 4. All stress values reported represent the average stress over the area of the smallest diameter of the couplings. The mean loads and load amplitudes for each of the four testing protocols are in FIG. 15. The equivalent fatigue stress cycles for four testing protocols are in FIG. 16. If failure did not happen, the test was stopped at 1.5 million cycles.

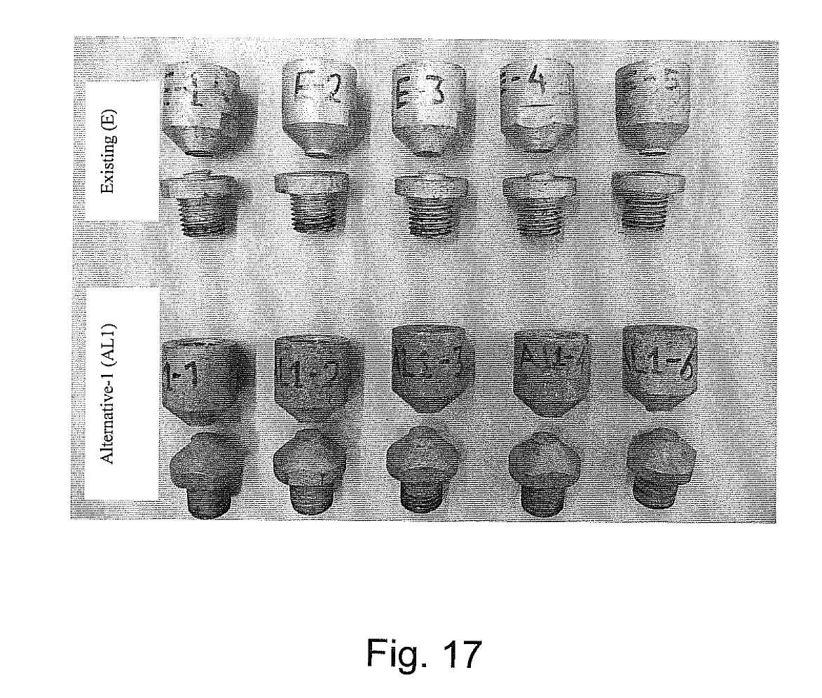

FIG. 17 shows photos of the fractured couplings under fatigue stress. All couplings from both types fractured at the reduced (necking) section. This indicates that the necking is the governing section in fatigue tests. The number of cycles to failure for all couplings is shown in Table 2.

TABLE 2
Number of Cycles to failure for fatigue tests of couplings

| | Test # | | | | | | | |
|---|---|---|---|---|---|---|---|---|
| | Test 1 | | Test 2 | | Test 3 | | Test 4 | |
| | Mean Load/Stress | | | | | | | |
| | 4.85 kip/17.98 ksi | | 6.37 kip/23.60 ksi | | 7.88 kip/29.22 ksi | | 9.40 kip/34.85 ksi | |
| Specimen # | Existing | Alternate | Existing | Alternate | Existing | Alternate | Existing | Alternate |
| 1 | 1,714,467 | 1,714,467 | 85,000 | 453,958 | 144,586 | 181,143 | 29,502 | 75,568 |
| 2 | 1,714,467 | 1,714,467 | 100,749 | 627,326 | 38,693 | 179,716 | 17,013 | 51,962 |
| 3 | 1,714,467 | 1,714,467 | 388,293 | 867,666 | 111,778 | 121,708 | 27,151 | 83,094 |
| 4 | 1,524,129 | 1,714,467 | 236,547 | 687,280 | 39,175 | 116,507 | 26,444 | 54,454 |
| 5 | 1,547,211 | 1,357,953 | 176,631 | 457,839 | 82,517 | 169,180 | 19,249 | 100,719 |
| Mean | 1,642,948 | 1,643,164 | 197,444 | 618,814 | 83,350 | 153,651 | 23,872 | 73,159 |
| Std | 98,271 | 159,438 | 122,861 | 173,045 | 46,110 | 31,923 | 5,419 | 20,391 |
| Deviation | | | | | | | | |
| COV % | 6% | 10% | 62% | 28% | 55% | 21% | 23% | 28% |

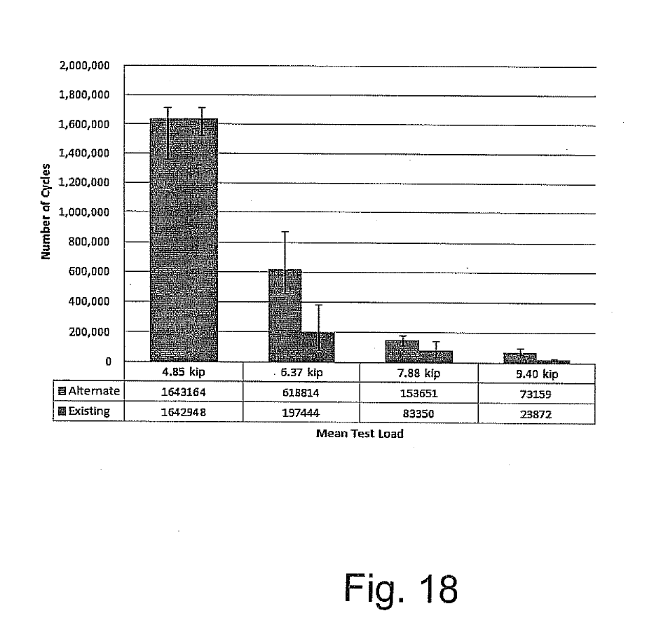

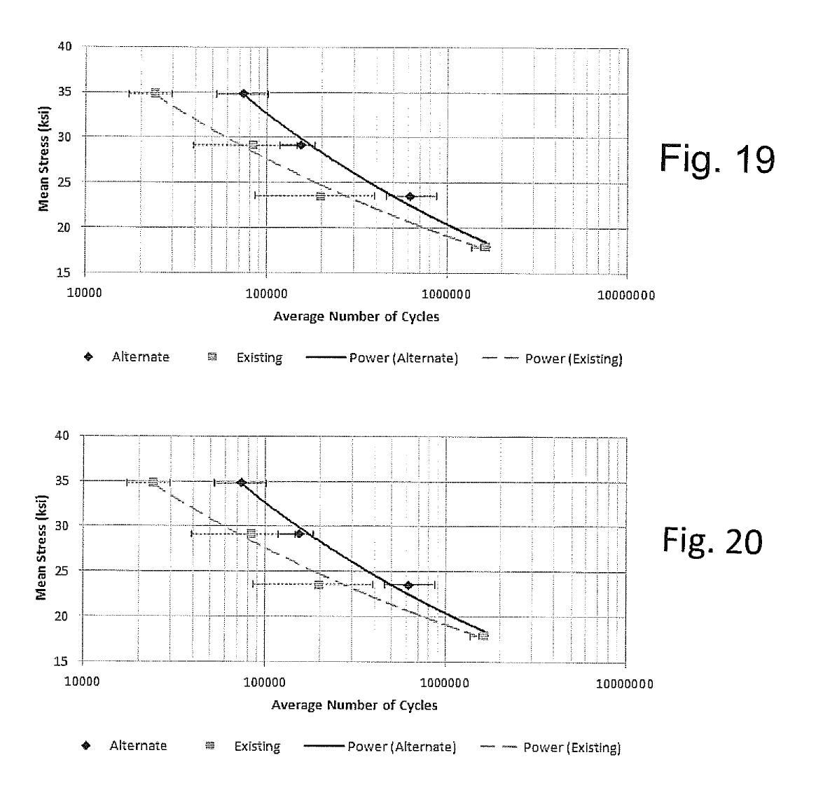

The number of cycles to failure for all couplers under tension fatigue loads is reported in Table 2. These results are summarized in FIG. 18 comparing the fatigue performance for both couplers. From Table 2 and FIG. 18 it can be noted that the Alternative coupler has higher fatigue strength than the Existing couplers. The number of cycles to failure for the Alternative couplers is twice to three times higher than the Existing couplers under the 6.37 kip, 7.88 kip and 9.40 kip test protocols. All the specimens of both couplers did not fail under the lowest mean load of 4.85 kip for Test Protocol-1 (except one Alternative coupler). Under this mean load, the test was stopped when the number of cycles reached 1.5 million cycles. The equivalent S-N curves for both types of couplers are shown in FIG. 19 and FIG. 20 using mean stress and stress range respectively.

The number of cycles to failure for all couplers under tension-compression (fully reversed fatigue) cycles is reported in Table 33.

TABLE 3
Number of cycles to failure for Tension/Compression fatigue tests.

| | Test | | | | | | | |
|---|---|---|---|---|---|---|---|---|
| | Test 5 | | Test 6 | | Test 7 | | Test 8 | |
| | Load/Stress Amplitude | | | | | | | |
| | ±455 kip/±16.9 ksi | | ±6.06 kip/±22.5 ksi | | ±6.80 kip/±25.2 ksi | | ±7.58 kip/±28.1 ksi | |
| Specimen # | Existing | Alternate | Existing | Alternate | Existing | Alternate | Existing | Alternate |
| 1 | 1,624,477 | 497,993 | 127,538 | 324,708 | 169,098 | 38,4780 | 155758 | 195,534 |
| 2 | 1,624,477 | 1,624,477 | 418,332 | 544,887 | 384,867 | 570,096 | 110145 | 217,828 |
| 3 | 1,624,477 | 1,624,477 | 804,302 | 734,075 | 150,785 | 561,196 | 85701 | 218,015 |
| 4 | 1,624,477 | 1,624,477 | 830,660 | 666,525 | 129,536 | 668,838 | 84476 | 136,038 |
| 5 | 1,624,477 | 1,624,477 | 305,865 | 659,294 | 121,668 | 582,866 | 72246 | 67,201 |
| Mean | 1,624,477 | 1,399,180 | 497,339 | 585,897 | 191,191 | 553,555 | 101,665 | 166,923 |
| Std | 0 | 503,779 | 310,236 | 161,048 | 109,848 | 103,642 | 33,218 | 65,035 |
| Deviation | | | | | | | | |
| COV % | 0 | 36% | 62% | 27% | 58% | 19% | 33% | 39% |

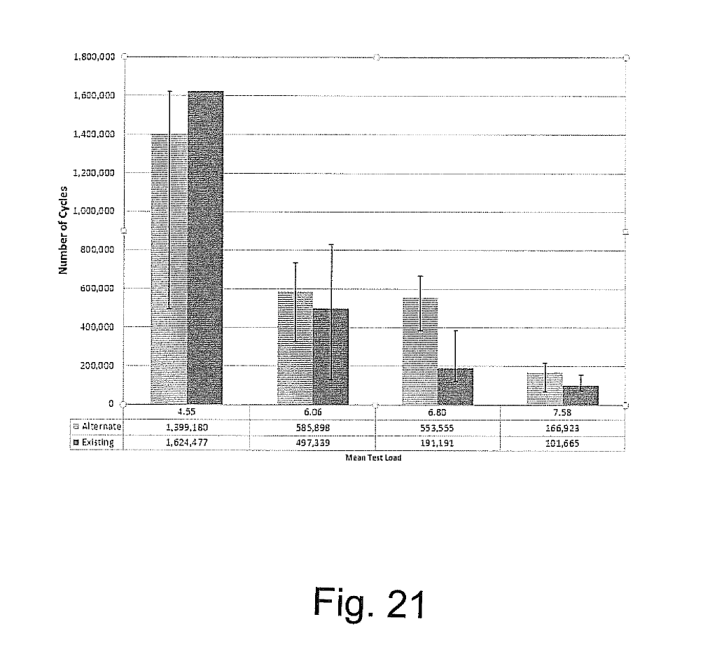

The results of this test are summarized in FIG. 21 comparing the fatigue performance for both couplers. It is also obvious from Table 3 and FIG. 21 that the Alternative coupler has higher fatigue strength than the Existing couplers. With the exception with a single anomaly failure of one Alternative coupler at stress range of ±4.55 kip, Alternative couplers have consistently shown a higher number of cycles to failure compared with Existing couplers. The number of cycles to failure for the Alternative couplers ranges from 1.2 to twice higher than the Existing couplers under the ±6.06 kip, ±7.55 kip test protocols. The equivalent S-N curves for both types of couplers under fully reversed fatigue cycles (zero mean stress) are shown in FIG. 22 using the stress range to represent fatigue stress.

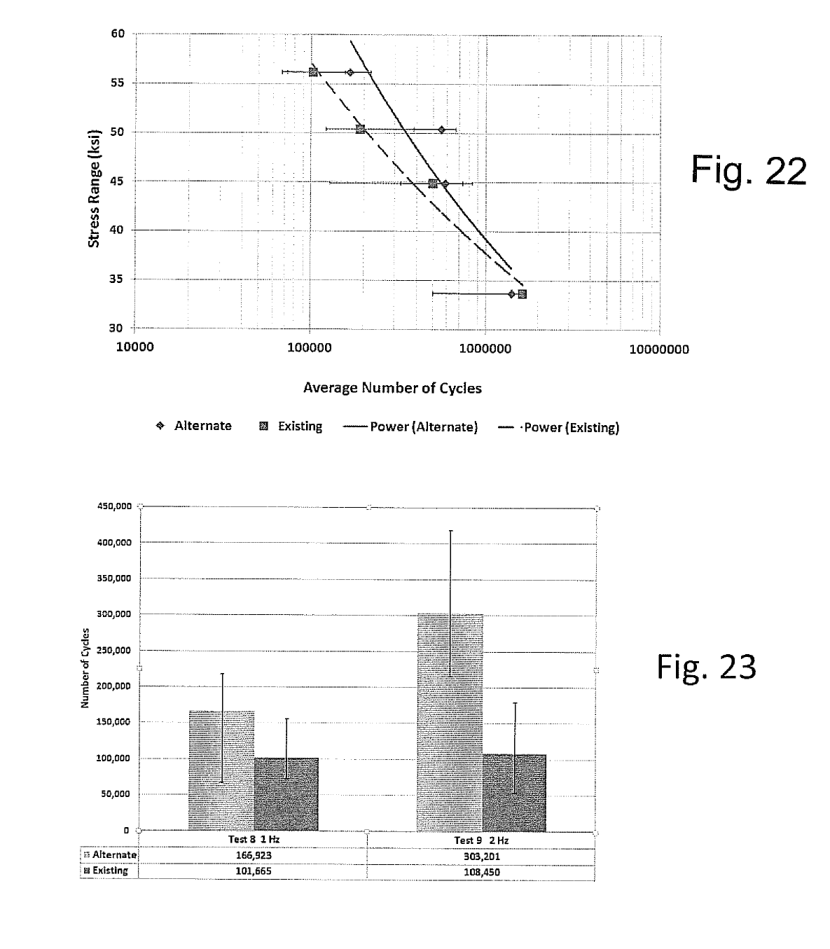

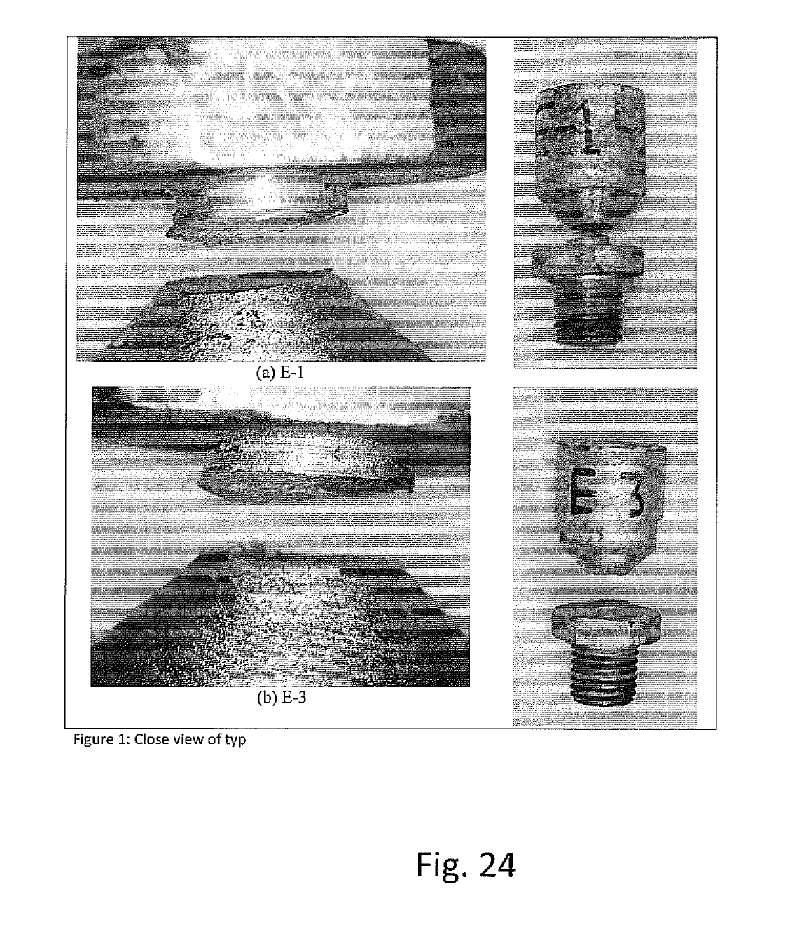

The significance of doubling the load frequency is presented Table 4 and FIG. 23.

TABLE 4
Number of cycles to failure for tension-compression fatigue test.

| | Test # | | | |
|---|---|---|---|---|
| | Test 8 | | Test 9 | |
| Load/Stress | | | | |
| Amplitude | ±7.58 kip/±28.1ksi | | ±7.58 kip/±28.1 ksi | |
| Frequency | 1 Hz | | 2 Hz | |
| Specimen # | Existing | Alternate | Existing | Alternate |
| 1 | 144,586 | 195,534 | 102,012 | 357,203 |
| 2 | 38,693 | 217,828 | 103,732 | 418,174 |
| 3 | 111,778 | 218,015 | 53,759 | 215,368 |
| 4 | 39,175 | 136,038 | 103,869 | 237,361 |
| 5 | 82,517 | 67,201 | 178,878 | 287,898 |
| Mean | 101,665 | 166,923 | 108,450 | 303,200 |
| Std Deviation | 33,218 | 65,035 | 44,821 | 84,289 |
| COV % | 33% | 39% | 41% | 28% |

It is noted that there is no effect on the Existing couplings as the load frequency change. However, The Alternative couplings capacity significantly increased under the high frequency fatigue loads. While using two frequencies only is not enough to judge the significance of frequency, it is evident that the change of frequency does not alter the major observations in these tests which indicate that the Alternative couplings have higher fatigue resistance than the Existing couplings.

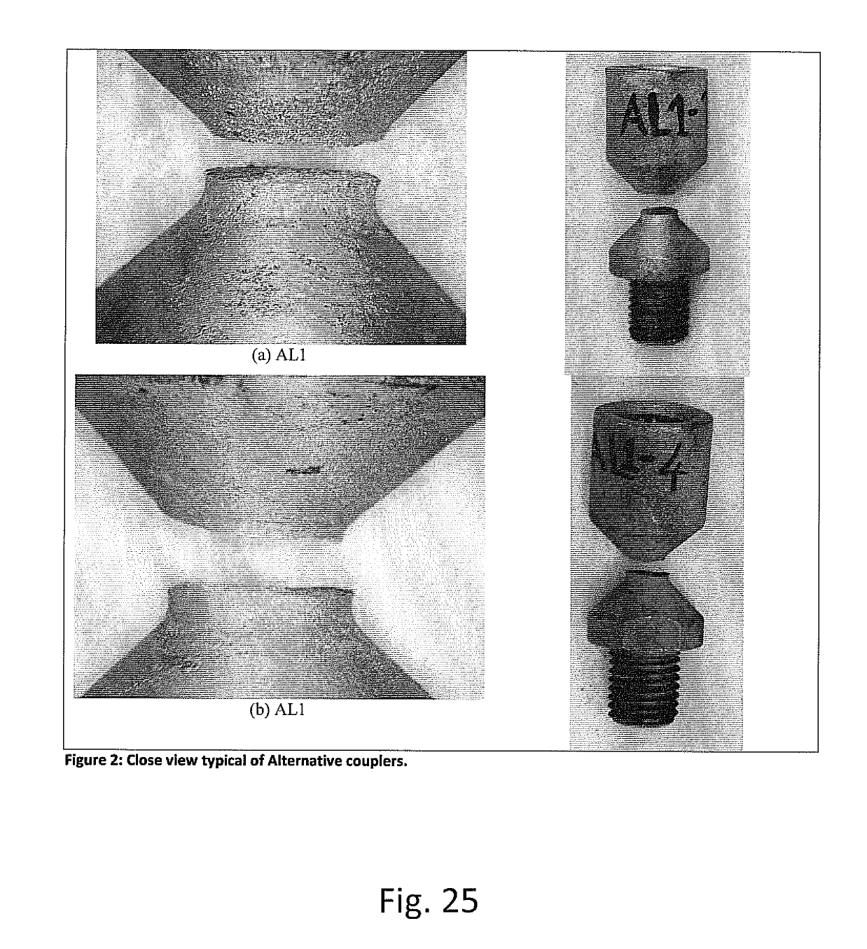

FIG. 24 and FIG. 25 show close views of the fractured couplers for the Existing and Alternative types respectively. FIG. 24 shows that the Existing type couplers fractured at the transition section between the cone and the short cylinder at the necking section. Failure occurred at this location because of the absence of a smooth geometrical transition between the cone and the short cylinder. Similarly, Error! Reference source not found.25 shows that fracture in the Alternative couplers occurred at the transition between the cone and the catenoid at the necking. Fracture observations of both types of couplers indicate that fatigue fracture does not necessarily occur at the smallest section. In fact, fracture is obviously related to high stress gradient developed close to the end of the necking zone in both types of couplers due to absence of smooth geometry transition. It is important to report that out of 90 tested couplers, two Existing couplers showed different fracture pattern. These two couplers failed by a crack propagating from the conical area towards the bolt thread instead of propagating through the small conical cross-section.

This FE analysis and the fatigue testing observations lead us to believe that the fabrication process of the necking might have a significant effect on the fatigue performance of the couplings. The relatively very small height for the catenoid leads to a non-smooth geometrical transition as in the case of geometry (G-2). Therefore, it is suggested that the curvature radius shall be increased to lead to a smoother geometrical transition, which will create less stress concentration and higher fatigue life than that observed with geometry (G-2).

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What claimed is:

1. In a break-away couplings having a central axis and a necked-down central region formed by two inverted truncated cones having larger and smaller bases joined at the smaller bases by a narrowed transition region in the form of a catenoid having a radius R and a central plane of symmetry at its inflection point of minimum diameter, the length of the side of cone between said bases being equal to 1, the distance along said axis between each large base and said central plane equal to H, and wherein:
$$\begin{matrix}{h}^{2} = {R}^{2} + {l}^{2} \\ Sin θ = \frac{{h}_{1}}{l} \\ Where \\ H = \sqrt{{( 0.521 - R )}^{2} + {( 0.57 )}^{2}} , BC = R , and \\ l = \sqrt{{( 0.521 - R + \sqrt{{R}^{2} - {h}_{2}^{2}} )}^{2} + {( {h}_{1} )}^{2}} \\ H = {h}_{1} + {h}_{2}\end{matrix}$$
where h₁=height of cones between bases, and
h₂=axial distance along central axis between each smaller base and said central plane.

2. In a break-away couplings as disclosed in claim 1, wherein a line extending along each cone is substantially tangent to said catenoid at each small base where each cone transitions to said catenoid.

3. In a break-away couplings as disclosed in claim 1, wherein h is approximately equal to 0.57″.

4. In a break-away couplings as disclosed in claim 1, wherein h₁<0.05″.

5. In a break-away couplings as disclosed in claim 1, wherein h₂<0.05″.

6. In a break-away couplings as disclosed in claim 1, wherein both h₁ and h₂ are each less than 0.05″.

7. In a break-away couplings as disclosed in claim 1, wherein d is selected to provide desired shear failure for a given coupling material.

8. In a break-away couplings as disclosed in claim 1, wherein the coupling is made of and d is selected to be equal to approximately 0.58″.

9. In a break-away couplings as disclosed in claim 1, wherein the coupling is made of and D₁ is selected to be equal to approximately 1.625″.

10. In a break-away couplings as disclosed in claim 1, wherein depth or length of said narrowed transition region is approximately equal to 2h₂.

11. In a break-away couplings as disclosed in claim 1, wherein 2h₂ approximately equal to 0.57″.

12. In a break-away couplings as disclosed in claim 1, wherein θ is selected to be within the range of 26°-44°.

13. In a break-away couplings as disclosed in claim 1, wherein θ is selected to be equal to 26°.

14. In a break-away couplings as disclosed in claim 1, wherein θ is selected to be equal to 37′.

15. In a break-away couplings as disclosed in claim 1, wherein the coupling is made of and θ, r, h and l are selected to provide fatigue failure at a number of cycles in excess of at least twice the number of cycles for conventional coupling.

16. In a break-away couplings as disclosed in claim 1, wherein r is selected to be within the range of 0.2″-0.5″.

17. In a break-away couplings as disclosed in claim 1, wherein h₂ is selected to be within the range of 0.28″-0.48″.

18. In a break-away couplings as disclosed in claim 1, wherein h₁ is selected to be within the range of 0.25″-0.12″.

19. In a break-away couplings having a central axis and a necked-down central region formed by two inverted truncated cones having larger and smaller bases joined at the smaller bases by a narrowed transition region defining a catenoid having a radius R and a central plane of symmetry at its inflection point of minimum diameter, the length of the side of cone between said bases being equal to 1, the distance along said axis between each large base and said central plane equal to H, and wherein:
$$\begin{matrix} {h}^{2} = {R}^{2} + {l}^{2} \\ Sin θ = \frac{{h}_{1}}{l} \\ {h}_{1} + {h}_{2} = h \\ {h}_{1} = Sin θ \sqrt{{( \frac{{D}_{1} - {D}_{2}}{2} - R + \sqrt{{R}^{2} - {h}_{2}^{2}} )}^{2} + {( {h}_{1} )}^{2}} ; and \\ R = \sqrt{{( \frac{{D}_{1} - {D}_{2}}{2} - R )}^{2} + {( h )}^{2} - {( \frac{{D}_{1} - {D}_{2}}{2} - R + \sqrt{{R}^{2} - {h}_{2}^{2}} )}^{2} - {( {h}_{1} )}^{2}}\end{matrix}$$
where h₁=height of cones between the larger and smaller bases D₁, D₂; and
h₂=axial distance along central axis between each smaller base and said central plane.

20. In a break-away couplings as disclosed in claim 19, wherein θ is selected to be within the range of 26°-44°.
